(19) United States
(12) Patent Application Publication
(10) Pub. No.: US 2013/0257088 A1
(43) Pub. Date: Oct. 3, 2013

(54) Easy On/Easy Off Windscreen

(71) Applicant: Terry B. Noble, Park Hill, OK (US)

(72) Inventor: Terry B. Noble, Park Hill, OK (US)

(21) Appl. No.: 13/748,806

(22) Filed: Jan. 24, 2013

Related U.S. Application Data
(60) Provisional application No. 61/618,719, filed on Mar. 31, 2012.

(51) Int. Cl. B60J 1/20

(52) U.S. Cl. CPC B60J 1/20
USPC 296/96.11

(57) ABSTRACT

Easily installed/removable wind deflecting device also provides noise reduction and temperature control within cockpit of automobile. Two major components: 1. Fitted vinyl/leather seat-caps/yoke/yoke flap 2. Auto safety glass. Seat-caps, joined together by yoke with yoke flap extending to center console of automobile, fit snuggly over headrest portion of seats. Auto safety glass, held in place by snaps in yoke fitted through holes in safety glass, is suspended between seats deflecting and rerouting normal airflow between, around and over seatbacks. Application is for all open-air/convertible automobiles. Variations of original include: factory/custom built seats with permanent caps fitted with snaps/zippers for installation/removal of yoke/safety glass wind deflecting device.

### RELATED APPLICATIONS

Pat. No. 4,761,030 Patent Date: Aug. 2, 1988

Pat. No. 5,702,150 Patent Date: Dec. 30, 1997

### BACKGROUND OF THE INVENTION

The idea for this windscreen evolved when my wife and I were enjoying a day out driving in our Corvette convertible. As we returned home late in the evening, the air had become much cooler. Rather than put the top up, between the two of us we wrapped a blanket around the seatbacks of the car, then leaned back on them in order to keep the blanket somewhat in place. This drastically changed the airflow, the wind noise, and the temperature within the car. It also made it possible for my wife to wear her long hair completely down, with no need for a cap, hair clip, or ponytail holder. Following this night I began to research the available products used for this purpose and found them to be lacking in the aspects of appearance, efficiency, and installation. Thus, I developed the Easy On/Easy Off Windscreen, which is highly efficient in reducing wind flow and wind noise within the car, and because it allows the temperature to remain easily controlled, thus more constant within the car (warmer or cooler depending on the season) it vastly extends our ability to use and enjoy our convertible car. The Easy On/Easy Off Windscreen is subtle and attractive, therefore it never detracts or draws attention away from the beauty of the automobile. The application of installation involves only the fitting of the vinyl seat-caps (much like a stocking cap fits on the human head) over the headrest portion of the car seats, requiring no modifications to the interior of the car, or use of bolts, screws, straps, etc. to secure it. Due to the use of auto safety glass, visibility is never obstructed, and the design of the Easy On/Easy Off Windscreen allows for the convertible top to be raised or lowered easily and safely with the windscreen remaining in place. When one wishes to remove the Easy On/Easy Off Windscreen, it lays completely flat and takes up very little space, allowing for it to be easily stored in the trunk of the car.

### BRIEF SUMMARY OF INVENTION

Easily installed/removable wind deflecting device also provides noise reduction and temperature control within cockpit of automobile. Two major components: 1. Fitted vinyl/leather seat caps/yoke/yoke flap 2. Auto safety glass. Seat-caps, joined together by yoke with yoke flap extending to center console of automobile, fit snuggly over headrest portion of seats. Auto safety glass, held in place by snaps in yoke fitted through holes in safety glass, is suspended between seats deflecting and rerouting normal airflow between, around and over seatbacks. Application is for all open-air/convertible automobiles.

### BRIEF DESCRIPTION OF DRAWINGS

FIG. 1: Shows a front view of fitted seat caps (#10), yoke with bottom yoke flap (#2) and auto safety glass wind diverter panel (#3). Also illustrates holes (#4) in auto safety glass wind diverter panel (#3). Dotted line (#5) illustrates outline of auto safety glass wind diverter panel (#3) sandwiched between vinyl yoke (#2) secured by snaps affixed to yoke (#2) and fitted through holes (#4) in auto safety glass wind diverter panel (#3). Fitted vinyl seat caps (#10) are placed over the headrest portion of the automobile seat backs (#6) suspending the auto safety glass wind diverter panel (#3) secured by snaps (#4) in vinyl yoke (#2).

FIG. 2: Illustrates factory issued (#6) or custom designed seats (#6) equipped with permanent zippers or snaps (#9) to secure vinyl yoke (#2) containing auto safety glass wind diverter panel (#3) to seats (#6). Pictured below vinyl yoke flap (#2) is center console (#8) of automobile.

### DETAILED DESCRIPTION OF THE INVENTION

The invention provides an easily installed, easily removable wind deflecting/blocking device that is suspended between the front seats of any convertible automobile, thus rerouting the airflow that normally occurs between, around and over top of the seatbacks. In addition to vastly reducing the airflow within the automobile, the invention also provides noise reduction, and greatly extends the convertible “season” by regulating and maintaining the temperature within the cockpit. The invention/windscreen is comprised of two major components. The first component is the fitted vinyl (or leather) seat caps which are joined together by a central vinyl (or leather) yoke, with a wind reducing flap that extends to the center console of the automobile. The seat caps fit snuggly over the headrest portions of the seats, much like a stocking cap fits over the human head. The yoke, which lies between the two seat caps, is fitted with snaps by which the second major component, the auto safety glass wind deflector panel, is held in place directly between the two front seats of the automobile. The safety glass has a series of six to eight holes (number of holes may be more or less, depending on the configuration of glass needed for any model of convertible car) drilled into its side edges. The snaps attached to the yoke portion of the device snap through the holes in the safety glass, thus securing the glass within the vinyl yoke and suspending it between the seats of the automobile. This application is for all open-air and convertible automobiles. Variations of the original invention will include: factory or custom built seats equipped with seat caps, permanently fixed to the headrest portion of the seats, that are fitted with snaps or zippers permanently in place for auto safety glass wind deflector panel, secured within vinyl (or leather) yoke, to be installed or removed.

### Claims

1. Due to the auto safety glass wind diverter panel being fitted tightly within the vinyl yoke, and the yoke flap being contoured to obstruct airflow in the area directly above the center console, the amount of airflow returning to the front seat area of the automobile is greatly reduced in comparison to all other previous wind stopping devices.

2. The Easy On/Easy Off Windscreen has no mechanical parts, allowing it to be attached or removed easily and in a fraction of the time it takes to do the same with other comparable devices, without the use of bolts, screws, straps or other fasteners, and requiring no damage or modifications to the interior or exterior of the automobile.

3. The application of auto safety glass provides for no obstruction of view, with the design of the invention allowing for the complete ease of raising or lowering the convertible top while the Easy On/Easy Off Windscreen remains securely in place.

### Description of Drawings

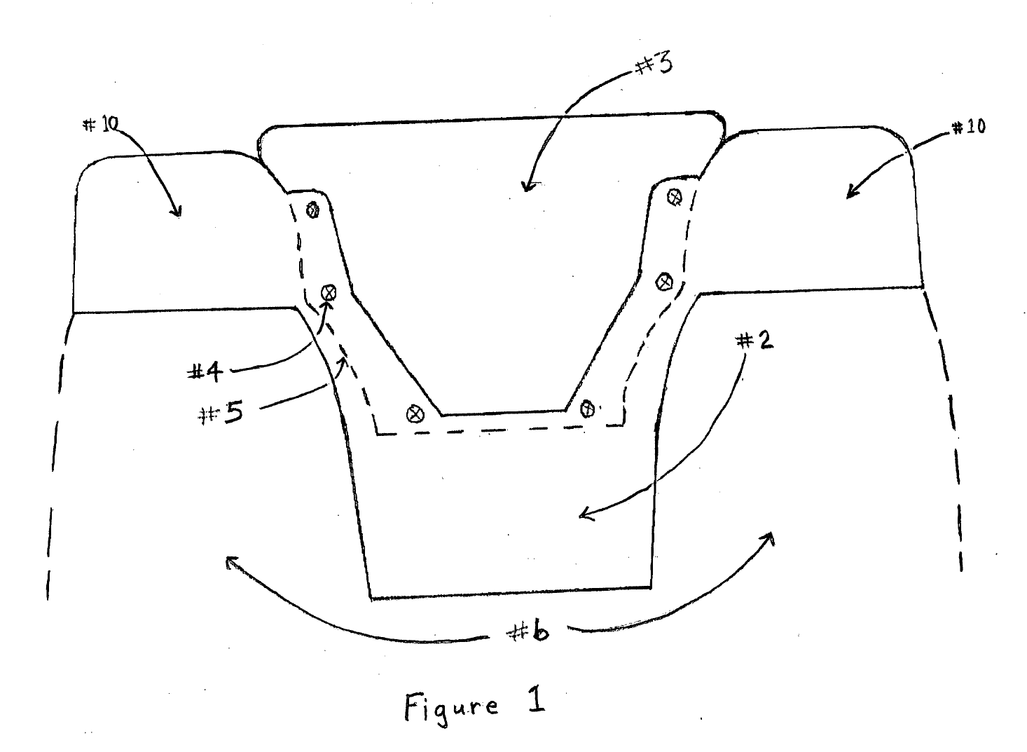

FIG. 1: Shows a front view of the fitted seat caps (#10), the yoke with bottom yoke flap (#2), and the auto safety glass wind diverter panel (#3).

Also illustrates holes (#4) in auto safety glass wind diverter panel (#3).

Dotted line (#5) illustrates outline of auto safety glass wind diverter panel (#3) sandwiched between vinyl yoke (#2) secured by snaps affixed to yoke (#2) and fitted through holes (#4) in auto safety glass wind diverter panel (#3).

Fitted vinyl seat caps (#10) are placed over the headrest portion of the automobile seat backs (#6) suspending the auto safety glass wind diverter panel (#3) secured by snaps (#4) in vinyl yoke (#2).

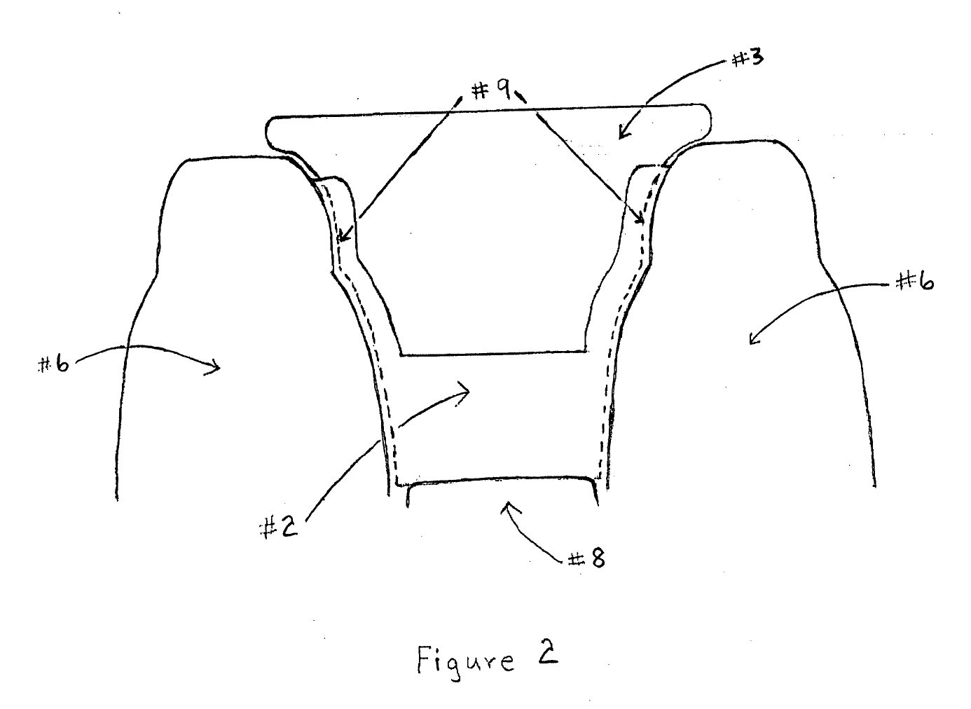

FIG. 2: Illustrates factory issued seats (#6) or custom designed seats (#6) equipped with permanent zippers or snaps (#9) to secure vinyl yoke (#2) containing auto safety glass wind diverter panel (#3) to seats (#6).

Seen below bottom yoke flap is center console (a) in automobile.

1. Due to the auto safety glass wind diverter panel being fitted tightly within the vinyl yoke, and the yoke flap being contoured to obstruct airflow in the area directly above the center console, the amount of airflow returning to the front seat area of the automobile is greatly reduced in comparison to all other previous wind stopping devices.

2. Dependent to claim #1: The efficiency with which this device redirects wind flow also contributes to greatly reduced wind noise and to the ability to establish and maintain a more constant temperature within the cockpit of the automobile which allows for extended seasonal use of the open air/convertible car.

3. The Easy On/Easy Off Windscreen has no mechanical parts, allowing for it to be put in place or removed easily and in a fraction of the time it takes to do the same with other comparable devices, without the use of bolts, screws, straps or other fasteners and with no damage or modifications occurring to the interior or exterior of the automobile.

4. Dependent to claim #2: The Easy On/Easy Off Windscreen's subtle uncomplicated design makes it attractive enough for the windscreen to remain in place as a permanent fixture, never detracting from the beauty of the automobile, however, if removed it lays completely flat and is easily stored in the trunk space of the car.

5. The application of auto safety glass combined with the design of the invention allows for an unobstructed view at all times, and the ability to raise and lower the convertible top with complete ease while the Easy On/Easy Off Windscreen remains securely in place.
